(19) United States
(12) Patent Application Publication
(10) Pub. No.: US 2026/0155408 A1
(43) Pub. Date: Jun. 4, 2026

(54) INTERDIGITATED FLOW FIELD WITH DIFFERENT RIB HEIGHTS FOR FLOW BATTERY REACTORS WITHOUT POROUS ELECTRODES

(71) Applicant: RTX CORPORATION, Arlington, VA (US)

(72) Inventor: James Demetrios Saraidaridis, East Hartford, CT (US)

(21) Appl. No.: 18/965,467

(22) Filed: Dec. 2, 2024

(51) Int. Cl. H01M 8/04082; H01M 8/18

(52) U.S. Cl. CPC H01M 8/04201; H01M 8/188

(57) ABSTRACT

A redox flow battery includes a flow field having ribs that define inlet channels interdigitated with outlet channels. A first rib is flush with a reference plane and a second rib is also provided that is shorter in height than the first rib. The second rib borders each of the inlet channels and each of outlet channels and an electrolyte over-rib-flow space is defined between a top surface of the second rib and the reference plane.

### BACKGROUND

This disclosure relates to flow batteries for selectively storing and discharging electric energy.

Flow batteries, also known as redox flow batteries or redox flow cells, are designed to convert electrical energy into chemical energy that can be stored and later released when there is demand. As an example, a flow battery may be used with a renewable energy system, such as a wind-powered system, to store energy that exceeds consumer demand and later release that energy when there is greater demand.

The flow battery includes a redox flow cell having a first and second flow field separated by an ion-exchange membrane and which is not adjacent to any electrode. A first and second electrolyte slurry containing active materials and conductive materials is delivered to the first or second flow field, respectively, to drive an electrochemically reversible redox reaction. Upon charging, the electrical energy supplied causes an electrochemical reduction reaction in one electrolyte and an oxidation reaction in the other electrolyte. The ion-exchange membrane prevents the electrolytes from mixing but permits selected ions to pass through to maintain electroneutrality. Upon discharge, the chemical energy contained in the electrolyte is released in the reverse reactions and electrical energy can be drawn directly from the electrolyte.

### SUMMARY

A redox flow battery according to an example of the present disclosure includes a first flow field having ribs that define inlet channels interdigitated with outlet channels. The ribs include a first rib and a second rib, the first rib has a first rib height and the second rib has a second rib height that is less than the first rib height. The second rib borders one of the inlet channels and one of the outlet channels such that there is an electrolyte over-rib-flow space between a top surface of the second rib and a reference plane. The reference plane is flush with a top surface of the first rib.

In a further embodiment of any of the foregoing embodiments, the first rib height of the first rib is at least thirty-five percent greater than the second rib height of the second rib.

In a further embodiment of any of the foregoing embodiments, each of the inlet and outlet channels includes a single, straight segment, and the inlet channels and the outlet channels are arranged in an alternating configuration.

In a further embodiment of any of the foregoing embodiments, the inlet channels have an unobstructed inlet and no outlet, and the outlet channels have an unobstructed outlet and no inlet.

In a further embodiment of any of the foregoing embodiments, each of the first and second ribs includes two sidewalls, and each inlet channel and each outlet channel borders at least one second rib at the sidewall.

In a further embodiment of any of the foregoing embodiments, each inlet channel and each outlet channel borders one first rib at the sidewall.

In a further embodiment of any of the foregoing embodiments, the first flow field includes an outer boundary that is defined by the first rib.

In a further embodiment of any of the foregoing embodiments, each of the ribs in the first flow field are second ribs except for the first ribs that define the outer boundary of the first flow field.

A further embodiment of any of the foregoing embodiments includes an ion-exchange membrane adjacent the first flow field and arranged in the reference plane.

In a further embodiment of any of the foregoing embodiments, the electrolyte over-rib-flow space has a top boundary and a bottom boundary, and the top boundary is defined by the ion-exchange membrane and the bottom boundary is defined by a top surface of the second rib.

A further embodiment of any of the foregoing embodiments includes an electrolyte storage tank connected in a circulation loop with the first flow field and the electrolyte storage tank stores an electrolyte slurry. Further, a pump is included and the pump is operable to pump the electrolyte slurry through the circulation loop, into the first flow field, and through the electrolyte over-rib-flow space from the one of the inlet channels to the one of the outlet channels.

In a further embodiment of any of the foregoing embodiments, the redox flow battery is electrodeless.

In a further embodiment of any of the foregoing embodiments, the electrolyte slurry contains active materials and conductive materials. The active materials include one or more of metallic, organic, organometallic, or ligand-modified metal compounds with redox-active properties, and the conductive materials include one or more of carbon, graphene, or metal-based compounds.

In a further embodiment of any of the foregoing embodiments, the electrolyte slurry has a viscosity that is from 4 to 1000 centipoise.

A further embodiment of any of the foregoing embodiments includes a supplementary flow field that includes channels configured in a straight, serpentine, or interdigitated pattern.

In a further embodiment of any of the foregoing embodiments, the supplementary flow field is arranged in series with the first flow field.

In a further embodiment of any of the foregoing embodiments, the supplementary flow field is arranged in parallel with the first flow field.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example flow battery.

FIG. 2 illustrates a top-sectional view of a flow field of the flow battery.

FIG. 3 illustrates a planar view of the flow field having interdigitated inlet and outlet channels.

FIG. 4 illustrates a cross-sectional view of a flow plate of the flow battery.

### DETAILED DESCRIPTION OF THE PREFERRED EMBODIMENT

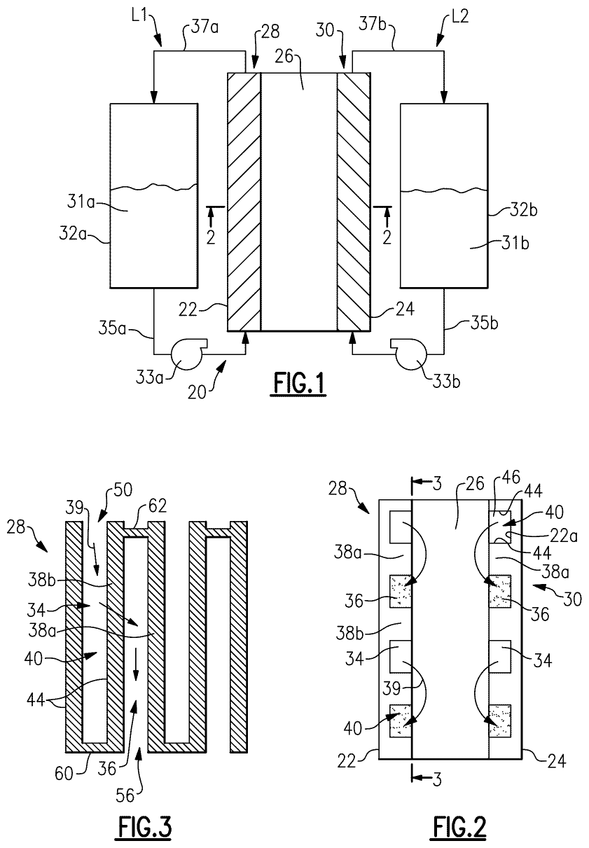

FIG. 1 illustrates selected portions of an example flow battery 20 for selectively storing and discharging electrical energy. As an example, the flow battery 20 may be used to convert electrical energy generated in a renewable energy system to chemical energy that can be stored until a later time at which there is demand for the electrical energy. The flow battery 20 may then convert the chemical energy into electrical energy for supply to an electric grid, for example.

In this example, the flow battery 20 includes a first flow plate 22, a second flow plate 24 spaced apart from the first flow plate 22, and an ion-exchange membrane 26 arranged adjacent the flow plates 22, 24. Referring to the sectioned view in FIG. 2, a first flow field 28 is located in the first flow plate 22, and a second flow field 30 is located in the second flow plate 24. In some examples, multiple repetitions of the flow field/membrane/flow field “cell” may be considered to be a repeating cell unit provided in a stacked arrangement. The flow battery 20 may also include a first electrolyte slurry storage tank 32a that is in fluid communication with the first flow field 28, and a second electrolyte slurry storage tank 32b that is in fluid communication with the second flow field 30. The first electrolyte slurry storage tank 32a is configured to hold a first electrolyte slurry 31a and the second electrolyte slurry storage tank 32b is configured to hold a second electrolyte slurry 31b.

The electrolyte slurries 31a and 31b are circulated by pumps 33a and 33b to the flow battery 20 through respective feed lines 35a and 35b, and are returned from the flow battery 20 to the storage tanks 32a and 32b via respective return lines 37a and 37b. As can be appreciated, additional pumps can be used if needed, as well as valves (not shown) at the inlets/outlets of the components of the flow battery 20 to control flow. In this example, the feed lines 35a and 35b and the return lines 37a and 37b connect the storage tanks 32a and 32b in respective circulation loops L1 and L2.

The electrolyte slurry 31a, 31b communicated through the flow battery 20 contains a carrier fluid and insoluble particulate materials suspended in the carrier fluid. The insoluble materials in electrolyte slurry 31a, 31b can be capable of undergoing reversible redox (reduction-oxidation) reactions or conduct electricity, or both. For example, the particulate material could include compounds of vanadium, iron, zinc, chromium, aluminum, halogens, titanium, manganese, cerium, organic molecules with redox active properties. Additionally, the slurry could include particulates that are electronic conductors, like metals or carbons like graphite or graphene. Typically, a flow battery includes electrodes to provide a conductive bulk material with surfaces that catalyze the redox reactions. However, a porous electrode is not necessary for the slurry 31a, 31b flow battery 20. For example, conductive particulates allow electrons to transport through the percolation network in the electrolyte slurry 31a, 31b, from one particle to the next, creating a conductive pathway and eliminating the need for electrodes. As a result, the disclosed flow battery 20 can be characterized as “electrodeless,” as it is operational to charge and discharge without electrodes. In instances where the particulates are not present in a high enough volume for percolation to create conductive pathways, conductive materials such as carbon and graphene may be added in order to enhance conductivity. Depending on the amount and type of carrier fluid and particulate, the viscosity of the electrolyte slurry 31a, 31b ranges from 4 to 1000 centipoise.

In operation, the storage tanks 32a, 32b deliver electrolyte slurry 31a, 31b to the respective first and second flow fields 28 and 30 to either convert electrical energy into chemical energy or convert chemical energy into electrical energy that can be discharged. The electrical energy is transmitted to and from the cell by an electrical pathway (not shown) that completes the circuit and allows the completion of the electrochemical redox reactions.

Each of the first and second flow fields 28 and 30 includes inlet channels 34 and outlet channels 36 for transporting the electrolyte slurries 31a, 31b through the flow battery 20. Referring to the sectioned views of the first flow field 28 in FIGS. 2, 3, and 4, the first flow plate 22 includes ribs 38 that define and separate the inlet channels 34 and the outlet channels 36. Further, the first flow plate 22 has a channel bed 22a and a bottom surface 22b. However, in some examples, the first flow plate 22 is arranged in a bipolar stack with ribs 38 and a channel bed 22a mirrored at a plane corresponding to the bottom surface 22b. Therefore, in the example where the first flow plate 22 is arranged in a bipolar stack, the bottom surface 22b is no longer present. Each of the FIGS. 2-4 are illustrated with respect to the first flow field 28. However, it is to be understood that the second flow field 30 and second flow plate 24 are similarly configured. The ribs 38 defining each channel 34, 36 can be either a first, tall rib 38a or a second, short rib 38b, as further explained below. The inlet channels 34 and outlet channels 36 each include a flow passage 40 that extends between the channel bed 22a of the first flow plate 22, two sidewalls 44 of the two ribs 38 positioned adjacent to the channels 34, 36, and an open top 46. The arrows 39 in FIG. 2 generally illustrate the flow direction of the electrolyte slurry 31a in the first flow field 28 from the inlet channels 34, over the ribs 38, and into the outlet channels 36.

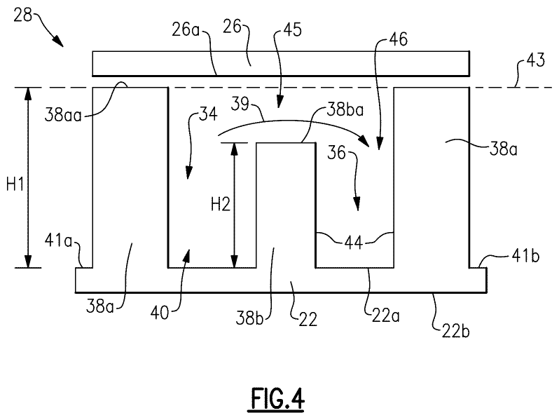

As shown in FIG. 3, the outlet channels 36 are interdigitated with the inlet channels 34. Specifically, the inlet channels 34 and outlet channels 36 alternate and are arranged adjacent and aligned to each other such that a single rib 38 separates the channels 34, 36. The first flow field 28 includes inlet channels 34 having inlets 50 for receiving an electrolyte slurry 31a and a first obstruction member 60 blocking the flow passage 40 of the inlet channel 34 in a location corresponding to where an outlet would be located but for the obstruction member 60. The outlet channels 36 each include an outlet 56 and a second obstruction member 62 blocks the flow passage 40 of the outlet channel 36 at a location corresponding to where an inlet would be located. Thus, the first obstruction member 60 fully blocks the outflow of electrolyte slurry 31a through the inlet channel 34 while the second obstruction member 62 fully blocks direct inflow of electrolyte slurry 31a into the outlet channel 36. Therefore, the electrolyte slurry 31a enters the inlet channel 34 through inlet 50. Since the inlet channel 34 lacks an outlet, the electrolyte slurry 31a is forced to flow over the second rib 38b into the outlet channel 36 in order to exit the first flow field 28, as generally indicated by flow arrows 39 (see also FIG. 2 and FIG. 4). The electrolyte slurry 31a can then freely flow out of the outlet channel 36 through the unobstructed outlet 56.

The interdigitated channels 34, 36 of the first flow field 28 facilitate large plan-form cell designs that operate at low pressure drop. Pressure drop may be caused from electrolyte slurry 31a flow resistance as the electrolyte slurry 31a flows though the channels 34, 36 and experiences friction along the ribs' 38 sidewalls 44 and the channel bed 22a of the first flow plate 22. Thus, the highest pressure is at the inlet 50 of the inlet channel 34 and the lowest pressure is at the outlet 56 of the outlet channel 36. This difference in pressure acts as a driving force for the electrolyte slurry 31a to flow over the second rib 38b, from a higher-pressure location to a lower pressure location, as indicated by flow arrows 39. For more viscous fluids, internal friction amplifies these effects. Since the electrolyte slurry 31a contains suspended and or dispersed solids, minimizing pressure drop helps to reduce parasitic system efficiency losses from pumping. Lower pressure requirements reduce the energy needed to drive the flow, thereby preserving overall system efficiency with respect to pumping power consumption. Still, it should be understood that the embodiments of interdigitated inlet and outlet channels 34 and 36 disclosed herein may be combined in series or in parallel with other, supplementary flow fields, including straight channel flow fields, serpentine channel flow fields, and/or additional flow fields having interdigitated channels. As such, these other flow fields combined in series with the first flow field 28 can be positioned either upstream or downstream of the first flow field 28. Additionally, these other flow fields combined in parallel with the first flow field 28 are arranged side by side with the first flow field 28.

FIG. 4 illustrates a cross-sectional view of a representative portion of the first flow field 28. In some prior flow field designs, the ribs 38 have uniform heights; however, here, the first rib 38a and second rib 38b have different heights to facilitate the flow of electrolyte slurry 31a through the flow field 28. As shown in FIG. 4, the first rib 38a has a height H1 and the second rib 38b has a height H2 and each rib 38a, 38b is positioned adjacent at least one of the inlet channel 34 or outlet channel 36. Here, “adjacent” means that the first rib 38a and second rib 38b share a border with the inlet channel 34 or outlet channel 36 at the sidewalls 44. The heights H1 and H2 represent the distance between the channel bed 22a of the first flow plate 22 and a top surface 38aa and 38ba of each rib 38a and 38b, respectively. The height H1 of the first rib 38a is greater than the height H2 of the second rib 38b. The first rib 38a is a “tallest” rib 38 in the flow field 28, and the second rib 38b is relatively shorter. There may be other ribs 38 positioned outside of the flow field 28 that are taller than the first rib 38a, but the first ribs 38a are the tallest in the flow field 28. For example, there may be other ribs 38 located outside of the flow field 28, such as to seal the first flow plate 22. In one example, the height H1 of the first rib 38a is at least 35% greater than the height H2 of the second rib 38b.

The first flow plate 22 includes two edges 41a, 41b that define a boundary of the first flow field 28, and as shown in FIG. 4, a first rib 38a is positioned at each edge 41a, 41b. That is, the first ribs 38a positioned at the respective edges 41a, 41b of the first flow plate 22 border only a single channel 38, which can be either an inlet channel 34 or an outlet channel 36. It is to be understood that the first flow plate 22 may include more channels 34, 36 and ribs 38 than what is depicted in FIGS. 2-4. Additionally, so long as a second rib 38b is positioned adjacent to each inlet channel 34 and outlet channel 36, it is to be understood that the first rib 38a and second rib 38b can be arranged in any suitable configuration to tailor the flow of electrolyte slurry 31a. Specifically, each inlet channel 34 and each outlet channel 36 borders at least one second rib 38b at the sidewall 44. FIG. 4 represents an alternating arrangement of the first, tall ribs 38a and second, short ribs 38b. However, in another example, the first ribs 38a are only located at the edges 41a, 41b, meaning those first ribs 38a have only one sidewall 44 bordering a channel 34, 36. In the same example, all other ribs 38 in the flow field 28 are second ribs 38b, each of which borders an inlet channel 34 or outlet channel 36 along both sidewalls 44.

As shown in the FIG. 4 embodiment, the top surface 38aa of the first rib 38a is arranged in a reference plane 43. In a further example, a bottom surface 26a of the ion-exchange membrane 26 lies in or substantially in the reference plane 43, though it is to be understood that the membrane 26 may “sag” somewhat into the channels 34 and 36. The relatively short height H2 of the second rib 38b results in an electrolyte over-rib-flow space 45 between the top surface 38ba of the second rib 38b and the reference plane 43, or ostensibly to the bottom surface 26a of the ion-exchange membrane 26. The electrolyte over-rib-flow space 45 allows the electrolyte slurry 31a to flow from the inlet channel 34, over the second rib 38b, and into the outlet channel 36, from which it exits through the outlet 56. This flow of electrolyte slurry 31a over the second rib 38b is illustrated generally by the arrow 39 in FIG. 4. Thus, the flow of electrolyte slurry 31a through the first flow field 28 can be tailored by adjusting the heights H1 and H2 of the first rib 38a and second rib 38b, respectively.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A redox flow battery comprising:
a first flow field including ribs that define inlet channels interdigitated with outlet channels, the ribs including a first rib and a second rib, the first rib having a first rib height and the second rib having a second rib height that is less than the first rib height; and
the second rib bordering one of the inlet channels and one of the outlet channels such that an electrolyte over-rib-flow space is defined between a top surface of the second rib and a reference plane, the reference plane being flush with a top surface of the first rib.

2. The redox flow battery of claim 1, wherein the first rib height of the first rib is at least thirty-five percent greater than the second rib height of the second rib.

3. The redox flow battery of claim 1, wherein each of the inlet and outlet channels comprises a single, straight segment, and the inlet channels and the outlet channels are arranged in an alternating configuration.

4. The redox flow battery of claim 3, wherein the inlet channels have an unobstructed inlet and no outlet, and the outlet channels have an unobstructed outlet and no inlet.

5. The redox flow battery of claim 1, wherein each of the first and second ribs includes two sidewalls, and each inlet channel and each outlet channel borders at least one second rib at the sidewall.

6. The redox flow battery of claim 5, wherein each inlet channel and each outlet channel borders one first rib at the sidewall.

7. The redox flow battery of claim 5, wherein an outer boundary of the first flow field is defined by the first rib.

8. The redox flow battery of claim 7, wherein each of the ribs in the first flow field are second ribs except for the first ribs that define the outer boundary of the first flow field.

9. The redox flow battery of claim 1, further comprising an ion-exchange membrane adjacent the first flow field and arranged in the reference plane.

10. The redox flow battery of claim 9, wherein the electrolyte over-rib-flow space has a top boundary and a bottom boundary, and the top boundary is defined by the ion-exchange membrane and the bottom boundary is defined by a top surface of the second rib.

11. The redox flow battery of claim 9, further comprising:
an electrolyte storage tank connected in a circulation loop with the first flow field, the electrolyte storage tank storing an electrolyte slurry; and
a pump operable to pump the electrolyte slurry through the circulation loop, into the first flow field, and through the electrolyte over-rib-flow space from the one of the inlet channels to the one of the outlet channels.

12. The redox flow battery of claim 11, wherein the redox flow battery is electrodeless.

13. The redox flow battery of claim 11, wherein the electrolyte slurry contains insoluble materials that are redox-active materials, electronically conductive materials, or both, the active materials including one of metallic, organic, organometallic, or ligand-modified metal compounds with redox-active properties, and the conductive materials including one or more of metal or carbon compounds.

14. The redox flow battery of claim 11, wherein the electrolyte slurry has a viscosity that is from 4 to 1000 centipoise.

15. The redox flow battery of claim 1, further comprising a supplementary flow field including channels configured in a straight, serpentine, or interdigitated pattern.

16. The redox flow battery of claim 15, wherein the supplementary flow field is arranged in series with the first flow field.

17. The redox flow battery of claim 15, wherein the supplementary flow field is arranged in parallel with the first flow field.
